(19) United States
(12) Patent Application Publication
(10) Pub. No.: US 2026/0238758 A1
(43) Pub. Date: Aug. 13, 2026

(54) TECHNIQUES OF REFERENCE PICTURE SELECTION FOR INTER MERGE TEMPORAL CANDIDATES

(71) Applicant: MEDIATEK INC., Hsinchu City (TW)

(72) Inventors: Hsin-Yi TSENG, Hsinchu City (TW); Yi-Wen CHEN, San Jose, CA (US); Chih-Wei HSU, Hsinchu City (TW); Ching-Yeh CHEN, Hsinchu City (TW)

(21) Appl. No.: 19/155,347

(22) PCT Filed: Feb. 7, 2024
(86) PCT No.: PCT/CN2024/076769

§ 371 Date: Aug. 11, 2025

Related U.S. Application Data
(60) Provisional application No. 63/485,017, filed on Feb. 15, 2023.

(51) Int. Cl. H04N 19/105; H04N 19/139; H04N 19/172; H04N 19/176; H04N 19/52

(52) U.S. Cl. CPC H04N 19/105; H04N 19/139; H04N 19/172; H04N 19/176; H04N 19/52

(57) ABSTRACT

In an aspect of the disclosure, a method, a computer-readable medium, and an apparatus are provided. The apparatus may be a coder. The coder constructs an inter merge candidate list that includes one or more temporal merge candidates. These candidates are derived from the motion information of a co-located coding unit (CU) in a co-located picture. The coder determines the reference picture index of the temporal merge candidate based on at least one criterion. Finally, the coder performs inter prediction for a current CU using the temporal merge candidate with the determined reference picture index.

### CROSS-REFERENCE TO RELATED APPLICATION(S)

This application claims the benefits of U.S. Provisional Application Ser. No. 63/485,017, entitled “METHODS AND APPARATUS OF REFERENCE PICTURE SELECTION FOR INTER MERGE TERMPORAL CANDIDATES” and filed on Feb. 15, 2023, which is expressly incorporated by reference herein in its entirety.

### BACKGROUND

### Field

The present disclosure relates generally to video coding systems, and more particularly, to techniques of selecting a reference picture for inter merge temporal candidates.

### Background

The statements in this section merely provide background information related to the present disclosure and may not constitute prior art.

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published in February 2021. VVC is developed based on its predecessor HEVC (High Efficiency Video Coding) by adding more coding tools to improve coding efficiency and also to handle various types of video sources including 3-dimensional (3D) video signals.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a coder. The coder constructs an inter merge candidate list that includes one or more temporal merge candidates. These candidates are derived from the motion information of a co-located coding unit (CU) in a co-located picture. The coder determines the reference picture index of the temporal merge candidate based on at least one criterion. Finally, the coder performs inter prediction for a current CU using the temporal merge candidate with the determined reference picture index.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIGS. 1A and 1B illustrate an exemplary adaptive Inter/Intra video coding system incorporating loop processing.

FIG. 2 is a diagram illustrating coding units (CUs).

FIG. 3 is a diagram illustrating an example of a CTU recursively partitioned by quadtree with a nested multi-type tree.

FIG. 4 is a diagram illustrating coding techniques employed by an encoder and a decoder.

FIG. 5 is a diagram illustrating template matching costs.

FIG. 6 is a flow chart 600 of a method for inter prediction of a current coding unit (CU).

FIG. 7 is a diagram 700 illustrating motion vector scaling for temporal merge candidate.

FIG. 8 is a diagram 800 illustrating candidate positions for temporal merge candidate.

FIG. 9 is a diagram 900 illustrating template and reference samples of the template for block with sub-block motion using the motion information of the subblocks of the current block.

FIG. 10 is a diagram 1000 illustrating SbTMVP process.

FIG. 11 is a diagram 1100 illustrating a coding method.

FIG. 12 is another diagram 1200 illustrating the coding method.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

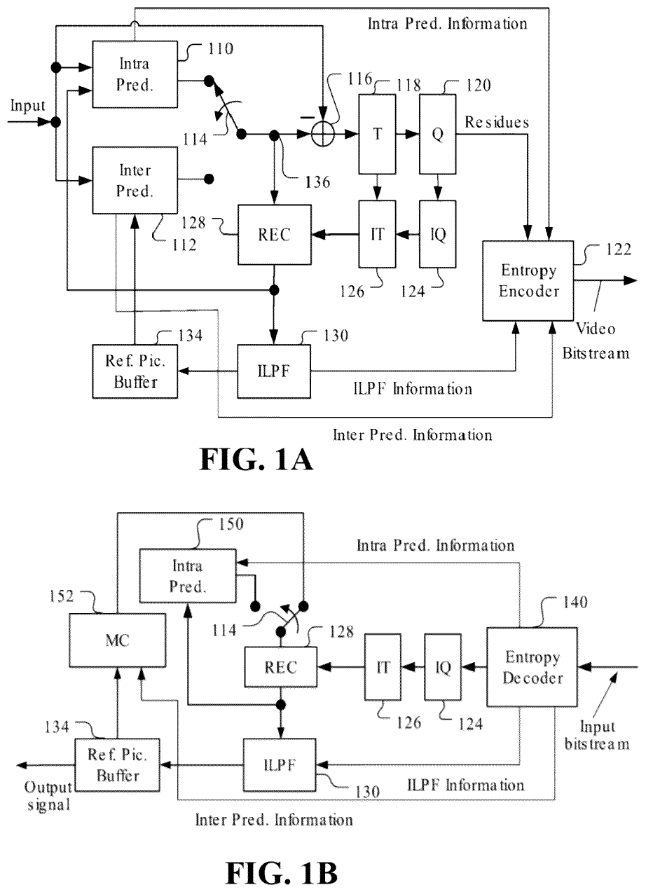

FIG. 1A illustrates an exemplary adaptive Inter/Intra video coding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H. 264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g., ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

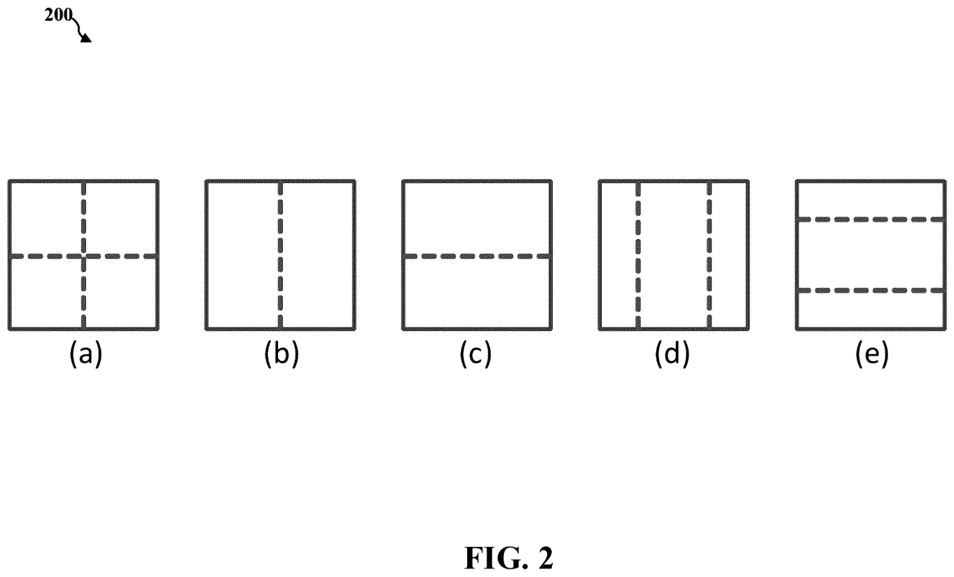

FIG. 2 is a diagram 200 illustrating coding units (CUs). In the Versatile Video Coding (VVC) standard, a coded picture is partitioned into non-overlapping square block regions represented by the coding tree units (CTUs). A coded picture can be represented by a collection of slices, with each slice comprising an integer number of CTUs. The individual CTUs within a slice are processed in a raster-scan order. A bidirectional predictive (B) slice may be decoded using either intra or inter prediction, employing at most two motion vectors and reference picture indices for predicting the sample values in each block. A predictive (P) slice is decoded using intra or inter prediction with no more than one motion vector and one reference picture index to predict the sample values of each block. An intra-coded (I) slice is decoded using only intra prediction.

A CTU may be divided into one or more non-overlapping coding units (CUs), utilizing a quadtree (QT) along with nested multi-type tree (MTT) structures which adapt to the various local motion and texture characteristics. A CU can be further sub-divided into smaller CUs using one of the five split types illustrated in FIG. 2.

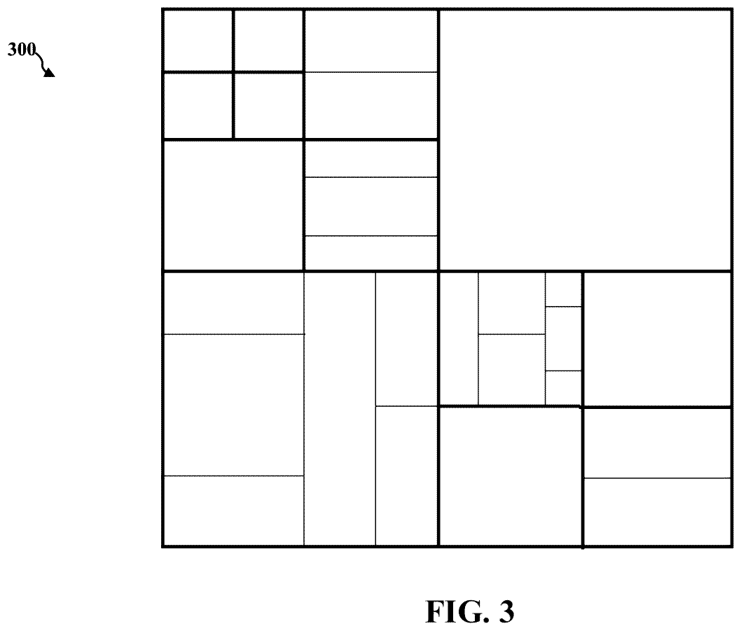

FIG. 3 is a diagram 300 illustrating an example of a CTU recursively partitioned by QT with the nested MTT. Each CU contains one or more prediction units (PUs). The prediction unit, along with its associated CU syntax, serves as a basic unit for signaling the predictor information. The designated prediction process is applied to predict the values of the associated pixel samples within the PU. Each CU may contain one or more transform units (TUs) representing the prediction residual blocks. A transform unit (TU) includes a transform block (TB) for luma samples and two corresponding transform blocks for chroma samples, where each TB corresponds to a residual block of samples from one color component. An integer-based transform is applied on a transform block to generate transform coefficients. The transform coefficients are further quantized. The level values of quantized transform coefficients, along with additional side information, are entropy-coded into the bitstream. The terms “coding tree block” (CTB), “coding block” (CB), “prediction block” (PB), and “transform block” (TB) define the 2-D sample array of a single color component associated with a CTU, CU, PU, and TU, respectively. As such, a CTU includes a luma CTB, two chroma CTBs, and the associated syntax elements. This relationship is consistent for CU, PU, and TU as well.

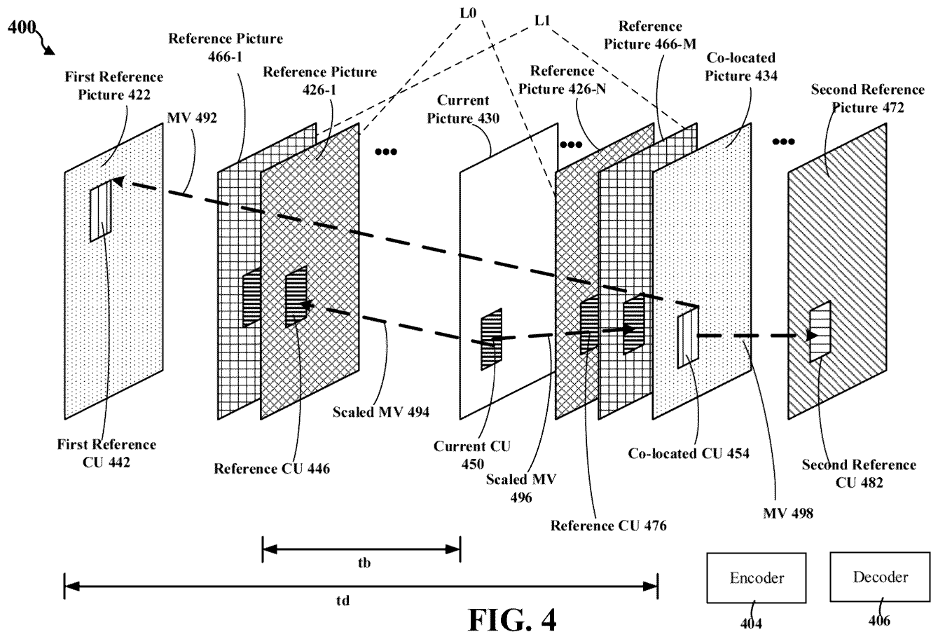

FIG. 4 is a diagram 400 illustrating coding techniques employed by an encoder 404 and a decoder 406. Inter prediction is a technique in video compression where a block in the current picture is predicted from reference blocks in previously coded reference pictures. This allows exploiting temporal redundancies across pictures. The merge mode in inter prediction allows conveniently reusing the motion information from spatial and temporal neighboring blocks for inter 30 prediction based on index signaling. This motion information includes motion vectors (MVs) pointing to the reference block, as well as the reference picture index.

In merge mode, the video encoder/decoder constructs a merge candidate list, which contains multiple merge candidates containing motion information. This list is constructed from spatial and temporal neighboring blocks that have motion information already available to exploit the spatial and temporal redundancy. The temporal candidates in the merge list are derived from a co-located block in a co-located picture. The motion vectors of the co-located block is scaled and included as a merge candidate. This candidate is referred to as the temporal merge candidate.

After the inter merge candidate list is constructed, containing both spatial and temporal candidates, the most optimal merge candidate is selected and signaled through its index in the list. The motion information of this selected candidate is then used to perform inter prediction for the current block.

A merge list is a set of candidate motion information including motion vectors and reference pictures (usually specified by the reference picture index) used for predicting the motion information of a current block (Coding Unit, CU) in a video frame. When encoding video, motion compensation is used, based on the motion information, to predict the content of a block by referencing other areas from one or multiple previously coded frames, which can significantly reduce the amount of data that needs to be encoded/decoded by exploiting temporal redundancies.

The merge list is constructed during the process of inter prediction, where blocks from previously encoded/decoded pictures (reference pictures) are used to predict the content of the current block. The merge mode allows the encoder to select the best prediction from a list of candidates without having to explicitly encode the motion vector (MV) and its corresponding reference picture index, thus saving bits.

The candidates in a merge list can include:
1. Spatial MVP (Motion Vector Prediction): Motion vectors from spatially neighboring blocks (CUs) that are already encoded/decoded.
2. Temporal MVP: Motion vectors from temporally neighboring blocks (collocated blocks) in reference frames.
3. History-based MVP: Motion vectors from a history list maintained by the encoder/decoder, typically using a FIFO (First-In, First-Out) approach.
4. Pairwise average MVP: Pairwise average candidates are generated by averaging predefined pairs of candidates in the existing merge candidate list, using the first two merge candidates.
5. Zero MVs: A motion vector indicating no motion, which can be useful for static scenes.

Further, the process of constructing an inter merge candidate list involves the inclusion of temporal merge candidates derived from collocated coding units (CUs). In this example, a current picture 430 includes a current CU 450. The current CU 450 is being processed for encoding or decoding.

In this example, to perform a first prediction, the encoder 404/decoder 406 may utilize a reference list L0 including L0 reference pictures 426-1 . . . 426-N. Further, the encoder 404/decoder 406 utilizes a co-located picture 434 including a co-located CU 454 and a corresponding first reference picture 422 of the co-located picture 434 including a first reference CU 442 of the co-located CU 454. The first reference CU 442 of the co-located CU 454 is indicated by the L0 motion vector 492.

To perform a second prediction, the encoder 404/decoder 406 utilizes a reference list L1 including L1 reference pictures 466-1 . . . 466-M. The encoder 404/decoder 406 also utilizes the co-located picture 434 including the co-located CU 454 and a corresponding second reference picture 472 of the co-located picture 434 including a second reference CU 482 of the co-located CU 454. The second reference CU 482 of the co-located CU 454 is indicated by the L1 motion vector 498.

The co-located picture 434 may be among the L0 reference pictures 426-1 . . . 426-N and L1 reference pictures 466-1 . . . 466-M.

In the context of video encoding and decoding, the process of constructing an inter merge candidate list involves the inclusion of temporal merge candidates derived from co-located coding units (CUs). Using the first prediction as an example, the encoder 404/decoder 406 derive a scaled motion vector for a temporal merge candidate. To achieve this, in this example, the encoder 404/decoder 406 utilizes the first co-located picture 434. Within this co-located picture, there is the first co-located CU 454, whose motion is to be used as a reference for predicting the motion of the current CU 450 in the current picture 430.

A motion vector 492 from the first co-located CU 454 to the first reference CU 442 of the co-located CU 454 is scaled to derive a motion vector 494 for the temporal merge candidate. This scaling is performed based on two picture order count (POC) differences: tb and td. The value of tb is defined as the POC difference between the current picture 430 and the reference picture (one selected from the reference list L0) of the current picture. Simultaneously, td is the POC difference between the first reference picture 422 of the co-located picture 434 and the first co-located picture 434. Note that the POC difference is always a positive integer.

By using these POC distances (the terms “POC differences” and “POC distances” are used interchangeably in this disclosure), the motion vector 492 from the co-located CU 454 is scaled appropriately. More specifically, the scaled motion vector 494, which is denoted as MV_{scaled}, may be computed as follows:

$${MV}_{scaled} = {MV}_{col\_CU} \times \frac{tb}{td}$$

where MV_{col_CU} is the original motion vector 492 from the first co-located CU 454 to its first reference CU 442 of the co-located CU 454. The result of this computation, MV_{scaled}, becomes the motion vector 494 for the temporal merge candidate, which is then used to predict the motion of the current CU 450 in the current picture 430.

The resulting scaled motion vector 494 becomes the temporal merge candidate's motion vector, which is then used to predict the motion in the current CU 450, thereby achieving a more accurate and efficient form of prediction. This technique allows the encoder to exploit temporal similarity effectively, and the decoder to accurately reconstruct the motion, leading to better video compression and reduced bitrates without significantly compromising on video quality.

Using the second prediction as another example, a motion vector 498 from the co-located CU 454 to the second reference CU 482 of the co-located CU 454 in the corresponding second reference picture 472 of the co-located picture 434 is scaled to generate a motion vector 496 for the temporal merge candidate. This scaling process is analogous to that used in the first prediction, relying on (a) POC differences between the reference picture (selected from the reference list L1) of the current picture 430 and the current picture 430 itself and (b) the POC difference between the second reference picture 472 of the co-located picture 434 and the co-located picture 434.

The temporal merge candidate derived from the first prediction scaled motion vector and the second prediction scaled motion vector is incorporated into the inter merge candidate list. This list is then used to select the best reference picture (via selecting the best merge candidate) for encoding or decoding the current CU 450.

The encoder 404/decoder 406 determines the appropriate reference picture index within each of the reference list L0 and the reference list L1 for each temporal merge candidate to achieve optimal prediction accuracy. This index selection is based on criteria that consider the temporal and quality-related characteristics of the available reference pictures.

In one configuration, the reference picture index is set to zero for both the reference list L0 and the reference list L1. That is, for the first motion vector 494, the L0 reference picture index is zero and the first reference picture is the first picture in the reference list L0, which contains the L0 reference pictures 426-1 . . . 426-N. Similarly, for the second motion vector 496, the L1 reference picture index is zero and the second reference picture is the first picture in the reference list L1, which contains the L1 reference pictures 466-1 . . . 466-M. Accordingly, the encoder 404 does not need to signal the L0 reference picture index or the L1 reference picture index.

In another configuration, the encoder 404/decoder 406 may employ various rules to determine the optimal reference picture index, denoted as N.

Under a first rule, with respect to a single reference list, the encoder 404 and decoder 406 may select the reference picture with the smallest POC distance from the current picture 430. For example, if the current picture has a POC of 8 and the reference list L0 contains pictures with POCs of [7, 6, 5, 0], the picture with POC 7 is chosen due to its minimal POC difference.

In scenarios where multiple reference pictures exhibit the same smallest POC difference relative to the current picture, additional criteria are applied. For example, if the current picture's POC is 2, and the reference list includes pictures with POCs of [0, 4, 8], the choice between pictures with equal POC distances involves further considerations.

Under a second rule, in a first sub-configuration of the current configuration, the picture with a smaller POCis selected. For example, if the current picture's POC is 2, and the reference list includes pictures with POCs of [0, 4, 8], then the reference picture with POC of 0 is selected. In a second sub-configuration of the current configuration, the picture with a larger POC (POC 4) is selected. For example, if the current picture's POC is 2, and the reference list includes pictures with POCs of [0, 4, 8], then the reference picture with POC of 8 is selected.

Under a third rule, the reference picture with smallest QP difference or distance (the terms “QP distance” and “QP difference” are used interchangeable in this disclosure) between it and the current picture is selected. For example, a current picture has POC 2 and QP 28, and a reference list L0 has pictures with POCs [0, 4, 8] and QPs [19, 26, 23]. The picture with POC 4 and QP 26 is then selected for its smallest QP difference from the current picture. A quantization parameter (QP) is a parameter used in video encoding and decoding that determines the level of quantization to apply when transforming and quantizing the residual (prediction error) signal. Specifically, the QP controls the step size of the quantization process-a higher QP value indicates a larger quantization step size and more coarse quantization, while a lower QP value indicates finer quantization with a smaller step size.

A smaller QP distance may translate to more consistent quantization between the reference samples and current samples. In another example, if the POC of the co-located picture is 32, the POC of its reference picture is 0, and the POC of the current picture is 16, the reference list for the current picture contains pictures with POCs [0, 32] and QPs [29, 31], while the current picture has a QP of 34. To determine the selection, the QP distances between each reference picture and the current picture are computed. The first reference picture has a QP distance of |29−34|=5. The second reference picture has a QP distance of |31−34|=3. Since the second reference picture has a smaller QP distance, it is selected as the optimal reference picture.

Under a fourth rule, in a first sub-configuration, the reference picture with a smaller QP in the reference list is selected. For example, a current picture has POC 2 and QP 28, and a reference list L0 has pictures with POCs [0, 4, 8] and QPs [19, 26, 23]. The picture with POC 0 and QP 19 is then selected for its QP is smaller than OPs of the other reference pictures in the reference list. In a second sub-configuration, the reference picture with a larger QP in the reference list is selected. For example, a current picture has POC 2 and QP 28, and a reference list L0 has pictures with POCs [0, 4, 8] and QPs [19, 26, 23]. The picture with POC 4 and QP 26 is then selected for its QP is larger than OPs of the other reference pictures in the reference list.

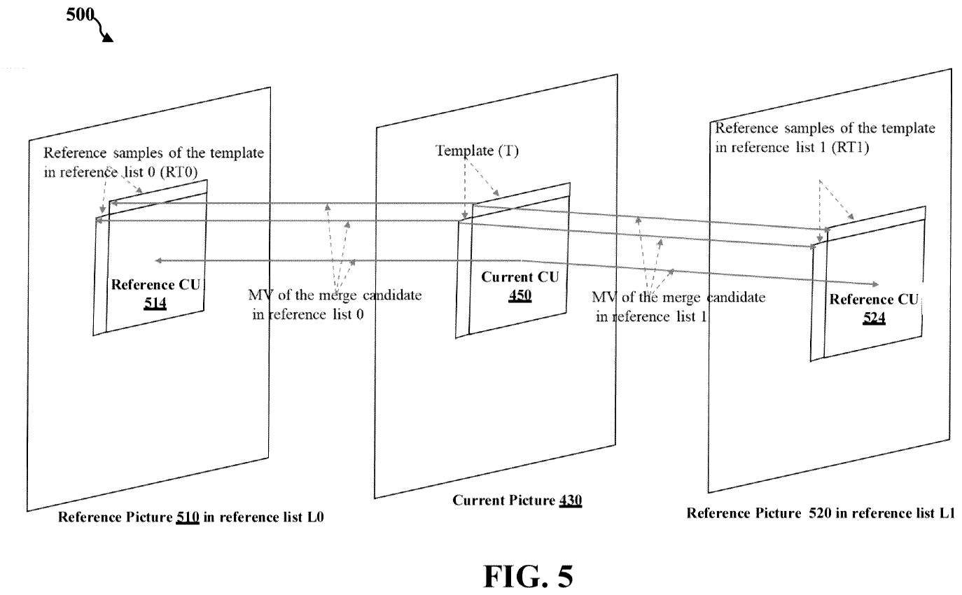

FIG. 5 is a diagram 500 illustrating template matching costs. As shown, the current picture 430 includes the current CU 450 and a current template (T) of the current CU 450. A reference picture 510 in the reference list L0 includes a first prediction reference CU 514 and a reference template (RT0) of the first prediction reference CU 514. A reference picture 520 in the reference list L1 includes a second prediction reference CU 524 and a reference template (RT1) of the second prediction reference CU 524.

A template matching cost is quantified by the Sum of Absolute Differences (SAD) between the reconstructed samples of the current CU 450's template, denoted as T, and the corresponding reference samples. The template T is composed of a set of reconstructed samples that are spatially neighboring to the current CU 450. These samples provide a reliable basis for predicting the current block's content.

The reference samples required for template matching are derived and located using the motion information of the merge candidate. For a merge candidate that utilizes bi-directional prediction, the reference samples are synthesized through bi-prediction. In FIG. 5, the reference samples of template T are generated based on the samples in template (RT0) of the first prediction reference CU 514 and the samples in template (RT1) the second prediction reference CU 524 using bi-prediction.

The SAD provides a cost measure that reflects the dissimilarity between the current block and the reference blocks. A lower SAD value indicates a higher similarity and, thus, a more suitable merge candidate for efficient motion compensation.

Referring back to FIG. 4, under a fifth rule, the encoder 404/decoder 406 may determine the optimal reference picture index, denoted as N, based on the template cost associated with the temporal merge candidate and the current CU 450. By selecting the reference picture index associated with the smallest template cost, the encoder 404 and decoder 406 can enhance the prediction process, leading to more efficient video compression. For instance, the encoder 404 and decoder 406 may compute the template costs for a temporal merge candidate associated with different reference picture indices within a reference list. Based on the computed costs, the index that yields the smallest template cost is chosen.

Under a sixth rule, the encoder 404/decoder 406 may select the reference picture based on the ratio between tb and td. This criterion aims to select a reference picture whose temporal distance ratio is closest to 1, thereby ensuring that the temporal scaling of the motion vector is as accurate as possible. For instance, if the POCs of the first co-located picture 434, the first reference picture 422 of the first co-located picture 434, and the current picture 430 are 4, 2, and 5 respectively, and the reference list for the current picture 430 is [4, 3, 2, 0], the reference picture with a POC of 3 is selected. This selection is made because the tb/td ratio of abs (5−3)/2 is closest to 1 among all the reference pictures in the list, where td=abs (4−2). When the tb/td ratio closest to 1 is associated with more than one reference picture, the encoder 404 and decoder 406 must apply another rule disclosed here to make a selection.

Under a seventh rule, in a first sub-configuration, the reference picture with the same prediction direction as the co-located picture/CU is chosen. For example, if the co-located picture/CU is predicted using forward prediction, and the POCs of the co-located picture, its reference picture, and the current picture are 32, 0, and 16 respectively, with the reference list of the current picture being [0, 32], then the encoder 404/decoder 406 selects the picture in the reference list with a POC of 0 for forward prediction of the current picture 430. Conversely, in another sub-configuration, the reference picture with a different prediction direction as the co-located picture is chosen. In the previous example where the co-located picture is predicted by forward prediction, and the POCs are as previously stated, the second picture in the reference list with a POC of 32 is chosen for backward prediction of the current picture 430.

Under an eighth rule, the encoder 404 and decoder 406 may either select the reference picture with the smaller POC or the one with the larger POC than the current picture 430, depending on the specific sub-configurations. In one sub-configuration, the encoder 404/decoder 406 selects the reference picture with the POC smaller than that of the current picture. For instance, the POC of the co-located picture is 32, the POC of the reference picture of the corresponding co-located picture is 0, and the POC of the current picture being processed is 16. The reference list for the current picture includes pictures with POCs [0, 32]. In this example, the reference picture in the reference list with a POC of 0 is selected because its POC is less than the POC of the current picture (0<16).

In another sub-configuration of the eighth rule, the encoder 404 and decoder 406 may instead select the reference picture with the POC greater than that of the current picture. Using the previous example, where the POCs of the co-located picture, the reference picture of the corresponding co-located picture, and the current picture are 32, 0, and 16, respectively, and the reference list for the current picture contains pictures with POCs [0, 32], the encoder 404/decoder 406 selects the reference picture in the reference list with a POC of 32 because it is greater than the POC of the current picture (32>16).

Further, the encoder 404 and decoder 406 may utilize a combination of rules described supra such as temporal information, prediction direction, template cost, and quantization parameters (QPs), etc. to determine the most suitable reference picture index N for predicting the current CU 450 within the current picture 430. More specifically, the encoder 404/decoder 406 initially applies one of the seven rules to determine the reference picture. However, there may be more than one reference picture in a reference list that satisfy the applied rule. The encoder 404/decoder 406 then may apply another one of the seven rules to further narrow the selection. These process may be continued with the rest of the rules until a single reference picture can be selected from the reference list according to the series of rules applied.

For example, the encoder 404/decoder 406 may initially apply the sixth rule to select a reference picture based on the tb/td ratio being closest to 1. However, if the tb/td ratio closest to 1 is associated with more than one reference picture, the encoder 404/decoder 406 may then apply the third rule to select the reference picture with the smaller QP distance from the current picture. For example, if the POC of the co-located picture is 32, the POC of its reference picture is 0, and the POC of the current picture is 16, then td=32. Assuming the reference list for the current picture contains pictures with POCs [0, 32] and QPs [29, 31], while the current picture has a QP of 34. In this case, both reference pictures have a tb/td ratio closest to 1. To further refine the selection, the QP distances between each reference picture and the current picture are computed. The first reference picture has a QP distance of |29−34|=5. The second reference picture has a QP distance of |31−34|=3. Since the second reference picture has a smaller QP distance, it is selected as the optimal reference picture.

The encoder 404/decoder 406, as described supra employs a selection mechanism for selecting the optimal reference picture index, denoted as N, for predicting the current CU 450 within the current picture 430. The selection mechanism may be governed by the set of eight rules described supra. These rules take into account various factors such as Picture Order Count (POC) distances, Quantization Parameter (QP) differences, template costs, and the temporal distance ratio between the current picture and the reference pictures.

The encoder 404/decoder 406 may explore all possible combinations of these eight rules to select the reference picture index. This leads to a total of

$${P}_{8}^{1} + {P}_{8}^{2} + … + {P}_{8}^{8}$$

permutations. The notation

$${P}_{n}^{r}$$

represents the number of permutations of n items taken r at a time.

For instance, the encoder 404/decoder 406 may initially apply the first rule to select a reference picture based on the smallest POC distance from the current picture. If this criterion leads to multiple potential reference pictures, the encoder 404/decoder 406 may then apply the third rule to choose the reference picture with the smallest QP difference from the current picture, aiming for more consistent quantization between the reference and current samples. If further refinement is needed, subsequent rules can be applied based on template costs, the tb/td ratio, or the prediction direction, among other criteria

In certain configurations, the encoder 404 and decoder 406 may utilize a “no backward prediction flag” to determine how to select the reference picture index N for the temporal merge candidate. Specifically, this flag indicates whether any of the reference pictures in the reference lists L0 and L1 of the current picture 430 have a POC greater than that of the current picture.

The reference pictures contained in lists L0 and L1 are predetermined for each current picture 430 according to certain rules or coding specifications. When encoding/decoding each current picture 430, the encoder 404 and decoder 406 can inspect the POCs of the reference pictures populated in L0 and L1 to determine if any reference picture has a POC greater than the current picture POC. If no such reference picture exists in either L0 or L1, then the encoder 404/decoder 406 would not perform backward prediction and the no backward prediction flag is set to true, indicating there is no backward prediction for the current picture. This flag then may be used to determine the criteria to select the optimal reference picture index N for temporal merge candidates derived for the current picture 430.

As described surpa, the encoder 404 and decoder 406 may determine the reference picture index N for temporal merge candidates based on various criteria, including POC distances, prediction directions, template cost, quantization parameters, and tb/td ratios.

Further, the encoder 404/decoder 406 may utilize the no backward prediction flag to decide the criteria to decide optimal reference picture index N. Specifically, when the POCs of all reference pictures in the reference lists L0 and L1 are smaller than the POC of the current picture, then there is no backward prediction for the current picture 430.

In one such configuration, if there is no backward prediction, the reference picture index associated with the tb/td ratio closest to 1 is chosen. Otherwise, if backward prediction exists, the reference picture index is set to 0.

Conversely, another configuration sets the reference picture index to 0 when there is no backward prediction, and selects the index associated with the tb/td ratio closest to 1 if backward prediction exists for the current picture.

Moreover, in one configuration, the reference picture index can be set to Mor the reference picture index associated with tb-td ratio closest to 1 based on the no backward prediction flag. Specifically, when there is no backward prediction, the index is set to M, which is determined by using one or more of the selection methods describe supra. When backward prediction does exist, the index associated with the tb/td ratio closest to 1 is chosen. Alternatively, the index can be set to M when backward prediction exists, and set to the reference picture index associated with tb/td ratio closest to 1 when there is no backward prediction. In this configuration, M can be a value less than the maximum length Lsₘₐₓ of the reference lists permitted in the video sequence.

In certain configurations, the selected reference picture index N may be explicitly signaled in the slice header (SH), picture header (PH), picture parameter set (PPS), or sequence parameter set (SPS). The signaling could be in the form of a flag or an additional syntax element that indicates how the reference picture index should be selected. For example, a flag set to a particular value might indicate that the reference picture index should be set to zero, while another value might suggest that the reference picture index should be selected based on the tb/td ratio closest to 1.

Alternatively, the signaling may indicate whether the reference picture index is to be explicitly provided or derived implicitly using the specified criteria. If the signaling indicates that the reference picture index is to be explicitly provided, an additional syntax element specifying the value of N would be included in the relevant headers or parameter sets.

In one configuration, a flag is signaled in the slice header (SH), picture header (PH), picture parameter set (PPS), or sequence parameter set (SPS) for determining the selection mechanism for the reference picture index of temporal merge candidates.

In a first sub-configuration, if the flag is set to 1, the reference picture index may be set to zero, which implies that the encoder 404 and decoder 406 will use the first picture in the respective reference list for prediction. Conversely, if the flag is set to 0, the index associated with the tb/td ratio closest to 1 is selected.

In a second sub-configuration, if the flag is set to 1, the encoder 404/decoder 406 selects the reference picture with the tb/td ratio closest to 1. If the flag is set to 0, the encoder 404/decoder 406 set the reference picture index to zero.

In a third sub-configuration, if the flag is set to 1, the encoder 404/decoder 406 selects a reference picture based on the index N, which is determined as described supra. If the flag is set to 0, the encoder 404/decoder 406 selects the reference picture with the tb/td ratio closest to 1.

In a fourth sub-configuration, if the flag is set to 1, the encoder 404/decoder 406 selects the reference picture with the tb/td ratio closest to 1. If the flag is set to 0, the encoder 404/decoder 406 selects a reference picture based on the index N, which is determined as described supra.

In a fifth sub-configuration, if the flag is set to 1, the reference picture index may be set to zero. If the flag is set to 0, the encoder 404/decoder 406 selects a reference picture based on the index N, which is determined as described supra.

In a sixth sub-configuration, if the flag is set to 1, the encoder 404/decoder 406 selects a reference picture based on the index N, which is determined as described supra. If the flag is set to 0, the reference picture index may be set to zero.

In one configuration, one additional syntax element is signaled in the slice header (SH), picture header (PH), picture parameter set (PPS) and/or sequence parameter set (SPS) to determine the reference picture index of temporal merge candidates. For example, if the value of the syntax element is N, the encoder 404 and decoder 406 set the reference picture index of the temporal merge candidate equal to N for the current CU 450.

In another configuration, one additional syntax element is signaled in SH, PH, PPS and/or SPS to indicate whether the reference picture index of the temporal merge candidate is explicitly signaled in these headers/parameter sets, or whether the reference picture index should be implicitly derived by the encoder 404 and decoder 406. When the additional syntax element indicates explicit signaling, another syntax element is transmitted in SH, PH, PPS and/or SPS containing the value of the reference picture index for the temporal merge candidate and current CU 450. The encoder 404 sends this explicit index and the decoder 406 sets the reference picture index equal to the received value. Conversely, when implicit derivation is indicated, the encoder 404 and decoder 406 determine the reference picture index using the criteria described previously, such as selecting the reference picture with the smallest POC distance from the current picture 430. By explicitly signaling the syntax element, the prediction process can be directly controlled. Implicit derivation provides more flexibility for the encoder 404 and decoder 406 to select an optimal reference based on automated algorithms.

In another aspect, the subblock-based temporal motion vector prediction (SbTMVP) is a prediction method in video coding that exploits temporal motion vector correlations at the sub-CU (sub-block) level to improve inter prediction.

SbTMVP predicts motion vectors at the sub-CU or sub-block level, unlike regular temporal MV prediction (TMVP) which operates at the CU level. So SbTMVP provides more granular and localized temporal MV prediction. SbTMVP applies a “motion shift” before fetching the temporal motion information from the corresponding block in the co-located picture. This motion shift is derived from the MV of a spatial neighbor of the current CU. After applying this motion shift to determine the co-located sub-CU location, the temporal motion vector and reference picture index of that co-located sub-CU is fetched and scaled to derive the motion prediction for the current sub-CU.

SbTMVP reuses available temporal motion vector correlations more locally and granularly at sub-CU level by first aligning the location using a spatial neighbor's motion shift, and then scaling the resulting co-located sub-CU's motion as prediction. This allows improving inter coding efficiency and compression performance.

In one configuration, the reference picture used by the SbTMVP may be different from the reference picture used by the temporal merge candidate (TMVP). For example, the encoder 404 and decoder 406 may always set the reference picture index for the SbTMVP to zero, irrespective of the reference picture selected for the TMVP candidate. In this case, for the SbTMVP candidate's L0 and L1 motion vectors, the corresponding reference picture may always be the first picture in the respective reference lists L0 and L1.

In another configuration, the encoder 404 and decoder 406 may always select the reference picture index associated with the tb/td ratio closest to 1 for the SbTMVP, while using a different criterion for selecting the TMVP reference picture.

Furthermore, the selection criterion for the SbTMVP reference picture may depend on whether there is backward prediction for the current picture 430 and current CU 450. For example, when there is no backward prediction, the reference picture index associated with the tb/td ratio closest to 1 may be chosen. Conversely, when there is backward prediction, the reference picture index may be set to zero for the SbTMVP candidate's motion vectors.

The encoder 404 and decoder 406 may also apply the reverse logic-set the SbTMVP reference picture index to zero when there is no backward prediction for the current picture, and choose the index associated with tb/td closest to 1 when there is backward prediction.

In yet another aspect, in one configuration, the selection of the reference picture index for the current CU 450 is determined based on the reference picture index selected by the neighboring blocks.

In one example, if both the above neighboring block and the left neighboring block of the current CU 450 set their respective reference picture indices to zero, the reference picture index of the current CU 450 is also set to zero. In this case, the first picture in the corresponding reference list (e.g., the reference list L0 or the reference list L1) is used as the reference picture for a corresponding prediction.

In another example, if both the above and left neighboring CUs select the reference picture index associated with the tb/td ratio closest to 1, the current CU 450 also selects its reference picture based on the tb/td ratio criterion described previously.

In one sub-configuration, if the above and left neighbors select their reference picture indices using different methods (e.g., one sets it to 0 while the other uses the tb/td ratio), the reference picture index of the current CU 450 is set to 0. In another sub-configuration, the current CU 450 in such a scenario will select its reference picture index based on the tb/td ratio closest 1.

By conditioning the reference picture selection for the current CU 450 on those selected by spatial neighbors, encoding efficiencies may also be improved by exploiting the correlations between the coding modes of nearby coding units.

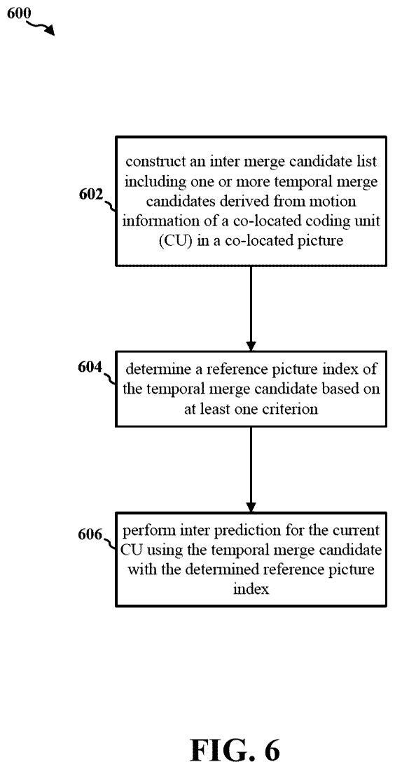

FIG. 6 is a flow chart 600 of a method for inter prediction of a current coding unit (CU). The method may be performed by a video coder (e.g., the encoder 404 and/or decoder 406). In operation 602, the coder constructs an inter merge candidate list including one or more temporal merge candidates derived from motion information of a co-located coding unit (CU) in a co-located picture. In operation 604, the coder determines a reference picture index of the temporal merge candidate based on at least one criterion. In operation 606, the coder performs inter prediction for the current CU using the temporal merge candidate with the determined reference picture index.

In certain configurations, the coder sets the reference picture index of the temporal merge candidate equal to zero. In certain configurations, the coder sets the reference picture index equal to N. N corresponds to a reference picture with a smallest picture order count (POC) distance from a current picture comprising the current CU.

In certain configurations, to determine the reference picture index, the coder identifies at least two reference pictures in a reference picture list with equal smallest POC distances from the current picture, and sets the reference picture index equal to an index, in the reference picture list, of the identified reference picture with a smaller POC.

In certain configurations, to determine the reference picture index, the coder identifies at least two reference pictures in a reference picture list with equal smallest POC distances from the current picture, and sets the reference picture index equal to an index, in the reference picture list, of the identified reference picture with a smaller quantization parameter (QP) difference relative to the current picture.

In certain configurations, to determine the reference picture index, the coder sets the reference picture index equal to N. N corresponds to a reference picture with a smallest QP difference relative to the current picture.

In certain configurations, to determine the reference picture index, the coder selects a reference picture index associated with a smallest template cost between the temporal merge candidate and the current CU.

In certain configurations, to determines the reference picture index, the coder identifies a reference picture, in a reference picture list, with a ratio between a first POC difference and a second POC difference closest to one. The first POC difference is between the current picture and a reference picture for the current picture in the reference picture list. The second POC difference is between the co-located picture and a reference picture for the co-located picture. The reference picture index is set equal to an index, in the reference picture list, of the identified reference picture. Further, in response to multiple reference pictures in the reference picture list having ratios closest to one, the coder selects the reference picture with a same prediction direction as the co-located picture.

In certain configurations, the coder determines whether there is backward prediction for the current picture. In response to determining that there is no backward prediction, the reference picture index is set equal to zero. In response to determining that there is backward prediction, the coder identifies a reference picture, in a reference picture list, with a ratio between a first POC difference and a second POC difference closest to one. The first POC difference is between the current picture and a reference picture for the current picture in the reference picture list. The second POC difference is between the co-located picture and a reference picture for the co-located picture. The reference picture index is set equal to an index, in the reference picture list, of the identified reference picture.

In certain configurations, the coder determines whether there is backward prediction for the current picture. In response to determining that there is backward prediction, the reference picture index is set equal to zero. In response to determining that there is no backward prediction, the coder identifies a reference picture, in a reference picture list, with a ratio between a first POC difference and a second POC difference closest to one. The first POC difference is between the current picture and a reference picture for the current picture in the reference picture list. The second POC difference is between the co-located picture and a reference picture for the co-located picture. The reference picture index is set equal to an index, in the reference picture list, of the identified reference picture.

In certain configurations, the coder determines whether there is backward prediction for the current picture. In response to determining that there is no backward prediction, the coder sets the reference picture index equal to an index determined based on one or more predetermined criteria.

In response to determining that there is backward prediction, the coder identifies a reference picture, in a reference picture list, with a ratio between a first POC difference and a second POC difference closest to one. The first POC difference is between a current picture comprising the current CU and a reference picture for the current picture in the reference picture list. The second POC difference is between the co-located picture and a reference picture for the co-located picture. The coder sets the reference picture index equal to an index, in the reference picture list, of the identified reference picture.

In certain configurations, the coder determines whether there is backward prediction for a current picture comprising the current CU. In response to determining that there is backward prediction, the coder sets the reference picture index equal to an index determined based on one or more predetermined criteria. In response to determining that there is no backward prediction, the coder identifies a reference picture, in a reference picture list, with a ratio between a first POC difference and a second POC difference closest to one. The first POC difference is between a current picture comprising the current CU and a reference picture for the current picture in the reference picture list. The second POC difference is between the co-located picture and a reference picture for the co-located picture. The coder sets the reference picture index equal to an index, in the reference picture list, of the identified reference picture.

In certain configurations, the coder signals, in at least one of a sequence parameter set, picture parameter set, adaptation parameter set, picture header, or slice header, a flag indicating whether the reference picture index of the temporal merge candidate is to be set equal to zero, an index determined according to a set of predetermined rules, or an index associated with a ratio closest to one. In certain configurations, the coder signals a syntax element in at least one of the sequence parameter set, the picture parameter set, the adaptation parameter set, the picture header, or the slice header to indicate whether the flag is signaled.

In certain configurations, the coder determines one or more criteria used to select reference picture indices for temporal merge candidates of one or more neighboring blocks of the current CU. The coder determines the at least one criterion for the temporal merge candidate of the current CU based on the one or more criteria.

In certain configurations, the one or more criteria are determined to be setting respective reference picture indices to zero. The at least one criterion is determined to be setting the reference picture index of the temporal merge candidate of the current CU to zero.

In certain configurations, the one or more criteria are determined to be selecting respective reference picture indices based on a ratio between a first POC difference and a second POC difference being closest to one. The at least one criterion is determined to be selecting the reference picture index of the temporal merge candidate of the current CU based on the ratio between the first POC difference and the second POC difference being closest to one.

In certain configurations, a reference picture index of a temporal merge candidate of a first neighboring block of the one or more neighboring blocks is set to zero. A reference picture index of a temporal merge candidate of a second neighboring block of the one or more neighboring blocks is a particular reference picture index selected for the second neighboring block based on a ratio between a first POC difference and a second POC difference associated with the second neighboring block. The at least one criterion is determined to be setting the reference picture index of the temporal merge candidate of the current CU to zero.

In certain configurations, a reference picture index of a temporal merge candidate of a first neighboring block of the one or more neighboring blocks is set to zero. A reference picture index of a temporal merge candidate of a second neighboring block of the one or more neighboring blocks is a particular reference picture index selected for the second neighboring block based on a ratio between a first POC difference and a second POC difference, associated with the second neighboring block, being closest to one. The at least one criterion is determined to be selecting the reference picture index of the temporal merge candidate of the current CU based on a ratio between a first POC difference and a second POC difference, associated with the current CU, being closest to one.

Further, the below description additionally describes various aspects the present disclosure. The below abbreviations are used through out the disclosure:
CU: Coding unit
CTB (LCU): Coding tree block (largest coding unit)
FIFO First-In, First-Out
HEVC: High Efficiency Video Coding
VVC: Versatile Video Coding
MC: Motion compensation
MV: Motion vector
MVP Motion Vector Prediction
SPS: Sequence parameter set
PPS: Picture parameter set
APS: Adaptation Parameter Set
PH: Picture Header
SH: Slice header
POC Picture Order Count
VVC Versatile Video Coding (Rec. ITU-T H.266|ISO/IEC 23090-3)

### Extended Merge Prediction

In VVC, the merge candidate list is constructed by including the following five types of candidates in order:
Spatial MVP from spatial neighbour CUs
Temporal MVP from collocated CUs
History-based MVP from an FIFO table
Pairwise average MVP
Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### Temporal Candidates Derivation

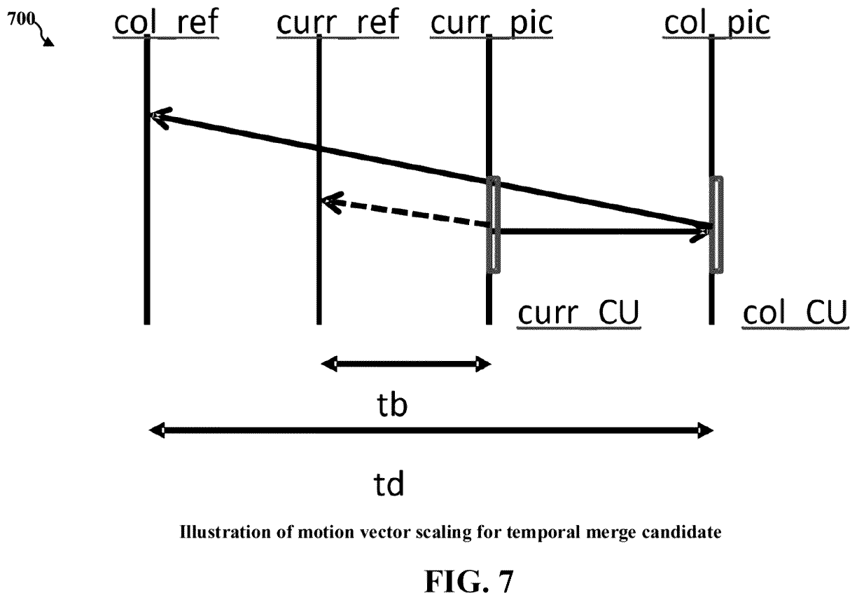

In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the dotted line in FIG. 7, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

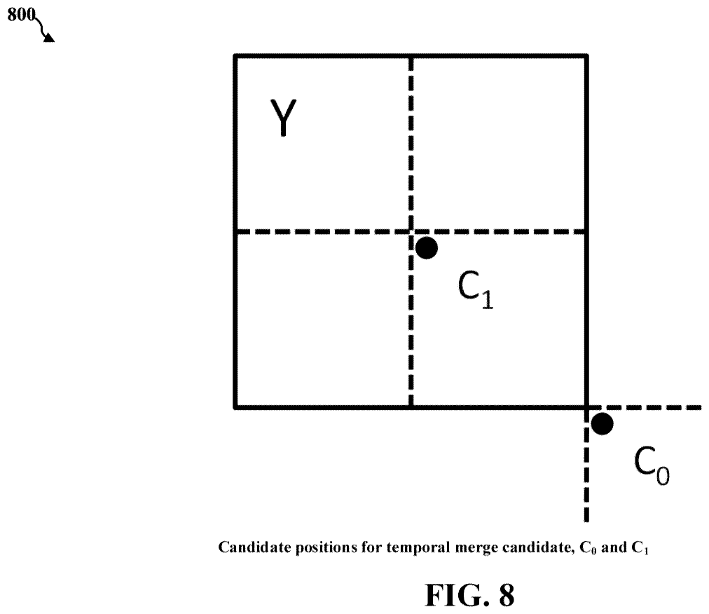

The position for the temporal candidate is selected between candidates C₀ and C₁, as depicted in FIG. 8. If CU at position C₀ is not available, is intra coded, or is outside of the current row of CTUs, position C₁ is used. Otherwise, position C₀ is used in the derivation of the temporal merge candidate.

Adaptive Reordering of Merge Candidates with Template Matching (ARMC-TM)

The merge candidates are adaptively reordered with template matching (TM). The reordering method is applied to regular merge mode, TM merge mode, and affine merge mode (excluding the SbTMVP candidate). For the TM merge mode, merge candidates are reordered before the refinement process.

An initial merge candidate list is firstly constructed according to given checking order, such as spatial, TMVPs, non-adjacent, HMVPs, pairwise, virtual merge candidates. Then the candidates in the initial list are divided into several subgroups. For the template matching (TM) merge mode, adaptive DMVR mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signalled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

### Cost Calculation

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 5.

### Refinement of the Initial Merge Candidate List

When multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

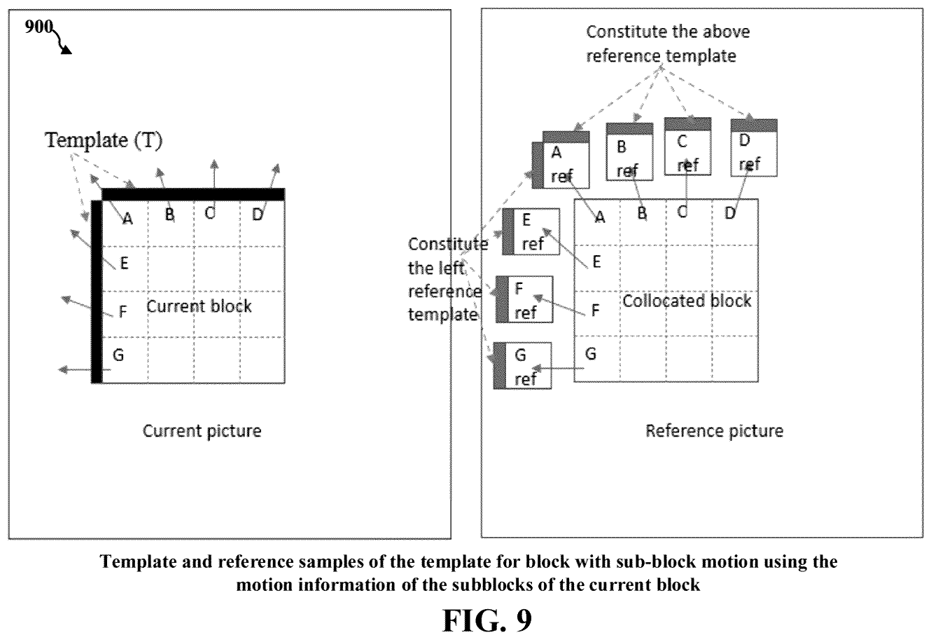

For subblock-based merge candidates with subblock size equal to Wsub×Hsub, the above template comprises several sub-templates with the size of Wsub×1, and the left template comprises several sub-templates with the size of 1×Hsub. As shown in FIG. 9, the motion information of the subblocks in the first row and the first column of current block is used to derive the reference samples of each sub-template.

Note, when wrap around motion compensation is enabled, the MV candidate shall be clipped with wrap around offset taken into consideration.

### MV Candidate Type Based ARMC

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

### Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

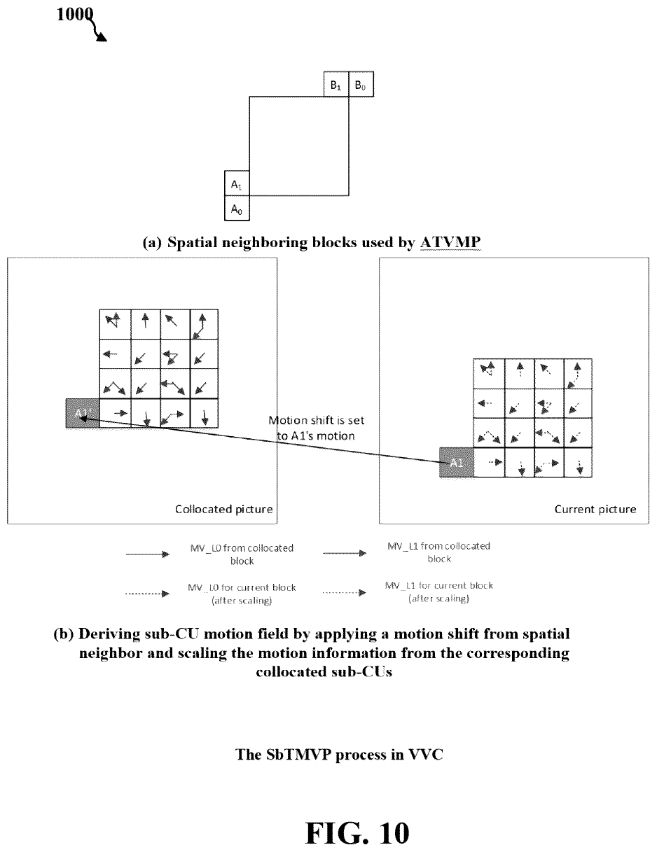

The SbTVMP process is illustrated in FIG. 10. SbTMVP predicts the motion vectors of the sub-CUs within the current CU in two steps. In the first step, the spatial neighbor A1 in FIG. 10(a) is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 10 (b). The example in FIG. 10 (b) assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### Proposed Method

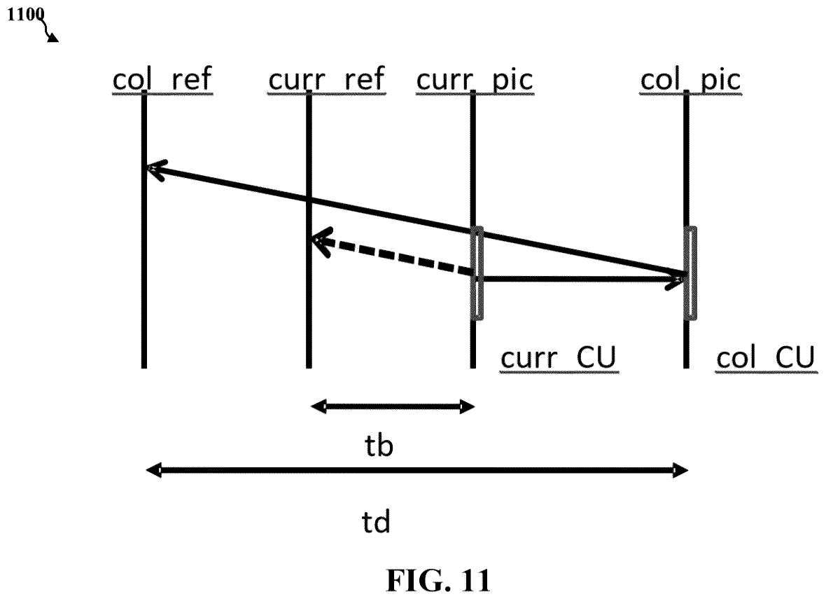

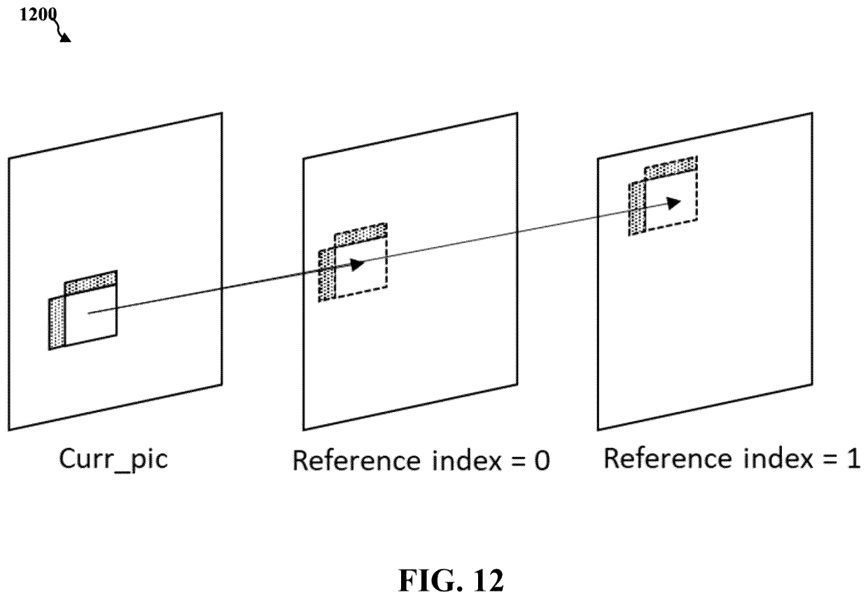

Referring to FIGS. 11-12, when constructing the inter merge candidate list, temporal merge candidates derived from collocated CUs are included. Let curr_ref denotes the reference picture of the current picture, curr_pic denotes the current picture, col_ref denotes the reference picture of the co-located picture, and col_pic denotes the co-located picture. A temporal merge candidate is derived based on 1) the motion vector of the co-located CU, 2) the POC difference between curr_ref and curr_pic (denoted as tb), and 3) the POC difference between col_ref and col_pic (denoted as td). The reference picture of the current picture (curr_ref) is one of the pictures in the reference list of the current picture. Hence, by determining the reference picture index, the reference picture of the current picture is determined. In this proposal, a method to determine the reference picture index (i.e. to determine curr_ref) is proposed to improve the prediction accuracy and the coding performance.

In one embodiment, the reference picture index of temporal merge candidate is set equal to zero. For the L0 motion vector of the temporal merge candidate, the L0 reference picture index is zero and curr_ref is always the first picture in reference list L0. For the L1 motion vector of the temporal merge candidate, the L1 reference picture index is zero and curr_ref is always the first picture in reference list L1.

In one embodiment, the reference picture index of temporal merge candidate is set equal to N, where N is determined by a criterion. For example, the reference picture with the smallest POC distance from the current picture is selected. If the POC of current picture is 8, the POCs of pictures in reference list are [7, 6, 5, 0], then the first picture (POC=7) is selected since its POC difference is the smallest. In another example, if there are two pictures whose POC difference between it and the current picture are both the smallest, the picture with the smaller POC is selected. If the POC of current picture is 2, the POCs of pictures in the reference list are [0, 4, 8], then the first picture (POC=0) is selected. For another example, if there are two pictures whose POC difference between it and the current picture are both the smallest, the picture with the larger POC is selected. If the POC of current picture is 2, the POCs of pictures in the reference list are [0, 4, 8], then the second picture (POC=4) is selected. For another example, if there are two pictures whose POC difference between it and the current pictures are both the smallest, the picture with smaller QP difference between it and the current picture is selected. For example, if the POC of current picture is 2, and the QP of current picture is 28. The POCs and QPs of the pictures in reference list 0 are [0, 4, 8] and [19, 26, 23]. Then the second picture (POC=4 and QP=26) is selected.

In another embodiment, the reference picture index of temporal merge candidate is set equal to N, where N is determined by a criterion. For example, the picture in the reference lists whose QP difference between it and the current picture is the smallest is selected. If the QP of current picture is 28, and the QPs of the pictures in the reference list are [19, 26, 23], then the second picture (QP=26) is selected. For another example, if there are more than one pictures in the reference lists whose QP difference between it and the current picture are the smallest, the picture with the smaller QP is selected. For another example, if there are more than one pictures whose QP difference between it and the current picture are the smallest, the picture with the larger QP is selected. For another example, if there are more than one pictures whose QP difference between it and the current picture are the smallest, the picture with the smaller POC distance is selected.

In another embodiment, the reference picture index of temporal merge candidate is set equal to N, where N is determined by a criterion. For example, the reference picture index could be selected by template cost. For one temporal merge candidate, the template cost between the temporal merge candidate, associated with different reference picture index, and the current block could be computed with the method described above. The reference picture index associated with the smallest template cost is selected.

In one embodiment, the reference picture of the temporal merge candidate can be selected from any one of reference picture in the list according to the ratio between tb and td. For every reference picture in a reference list, the reference picture with the ratio closest to 1 is select. For example, if the POC of col_pic, the POC of col_ref, and the POC of curr_pic are 4, 2, 5 respectively and the reference list of the curr_pic is [4, 3, 2, 0]. td=abs (4-2)=2. The second picture in the reference list is select since its tb/td ratio abs (5−3)/2 is closest to 1 among tb/td ratios of all the reference pictures in the list.

In one sub-embodiment, if the tb-td ratio closest to 1 is associated with more than one reference pictures, the reference picture with the same prediction direction as the col_pic is selected. For example, if the POC of col_pic, the POC of col_ref, and the POC of curr_pic are 32, 0, 16 respectively and the reference list of the curr_pic is [0, 32]. Since col_pic is predicted by forward prediction (the POC of col_ref<the POC of col_pic), the first picture in the reference list (POC=0) is selected.

In another sub-embodiment, if the tb-td ratio closest to 1 is associated with more than one reference pictures, the reference picture with the different prediction direction as the col_pic is selected. For example, if the POC of col_pic, the POC of col_ref, and the POC of curr_pic are 32, 0, 16 respectively and the reference list of the curr_pic is [0, 32]. Since col_pic is predicted by forward prediction (the POC of col_ref<the POC of col_pic), the second picture in the reference list (POC=32) is selected.

In another sub-embodiment, if the tb-td ratio closest to 1 is associated with more than one reference pictures, the reference picture with the POC smaller than the curr_pic is selected. For example, if the POC of col_pic, the POC of col_ref, and the POC of curr_pic are 32, 0, 16 respectively and the reference list of the curr_pic is [0, 32]. The first picture in the reference list (POC=0) is selected since 0<16.

In another sub-embodiment, if the tb-td ratio closest to 1 is associated with more than one reference pictures, the reference picture with the POC bigger than the curr_pic is selected. For example, if the POC of col_pic, the POC of col_ref, and the POC of curr_pic are 32, 0, 16 respectively and the reference list of the curr_pic is [0, 32]. The second picture in the reference list (POC=32) is selected since 32>16.

In one sub-embodiment, if the tb-td ratio closest to 1 is associated with more than one reference pictures, the reference picture with the smaller QP distance from the current picture is selected. For example, if the POC of col_pic, the POC of col_ref, and the POC of curr_pic are 32, 0, 16 respectively. Hence td=32. The POC and QP of the reference list of the curr_pic is [0, 32] and [29, 31]. The QP of current picture is 34. Then the second picture (POC=32 and QP=31) is selected since its QP distance is smaller.

In one embodiment, the reference picture index of temporal merge candidate could be set equal to zero or the reference picture index associated with tb-td ratio closest to 1 is selected on condition of whether there is no backward prediction for the current picture. When there no backward prediction for the current picture, the POCs of all the reference pictures in the reference lists of the current picture are smaller than the POC of the current picture. For one example, the reference picture index associated with tb-td ratio closest to 1 is selected when there is no backward prediction for the current picture, and the reference picture index is set equal to zero when there is backward prediction for the current picture. For another example, the reference picture index is set equal to zero when there is no backward prediction for the current picture, and the reference picture index associated with tb-td ratio closest to 1 is selected when there is backward prediction for the current picture.

In one embodiment, the reference picture index of temporal merge candidate could be set equal to N or the reference picture index associated with tb-td ratio closest to 1 is selected on condition of whether there is no backward prediction for the current picture. When there no backward prediction for the current picture, the POCs of all the reference pictures in the reference lists of the current picture are smaller than the POC of the current picture. Let the maximum length of reference lists of the whole video sequence be Ls_max. N has to be smaller than Ls_max. For one example, the reference picture index associated with tb-td ratio closest to 1 is selected when there is no backward prediction for the current picture, and the reference picture index is set equal to N when there is backward prediction for the current picture. For another example, the reference picture index is set equal to N when there is no backward prediction for the current picture, and the reference picture index associated with tb-td ratio closest to 1 is selected when there is backward prediction for the current picture.

In one embodiment, a flag is signaled in SH, PH, PPS and/or SPS to determine how to select the reference picture index of temporal merge candidates. For example, if the flag is set to 1, the reference picture index of temporal merge candidate is set equal to 0. If the flag is set to 0, the reference picture index associated with tb-td ratio closest to 1 is selected. For another example, if the flag is set to 1, the reference picture index associated with tb-td ratio closest to 1 is selected. If the flag is set to 0, the reference picture index of temporal merge candidate is set equal to 0. For another example, if the flag is set to 1, the reference picture index of temporal merge candidate is set equal to N. If the flag is set to 0, the reference picture index associated with tb-td ratio closest to 1 is selected. For another example, if the flag is set to 1, the reference picture index associated with tb-td ratio closest to 1 is selected. If the flag is set to 0, the reference picture index of temporal merge candidate is set equal to N. For still another example, if the flag is set to 1, the reference picture index of temporal merge candidate is set equal to N. If the flag is set to 0, the reference picture index of temporal merge candidate is set equal to 0. For another example, if the flag is set to 1, the reference picture index of temporal merge candidate is set equal to 0. If the flag is set to 0, the reference picture index of temporal merge candidate is set equal to N.

In one embodiment, one additional syntax element is signaled in SH, PH, PPS and/or SPS to determine the reference picture index of temporal merge candidates. For example, if the value of the syntax element is N, the reference picture index of temporal merge candidate is set equal to N.

In one embodiment, one additional syntax element is signaled in SH, PH, PPS and/or SPS to indicate the whether the reference picture index of temporal mv candidate is explicitly signaled in SH, PH, PPS and/or SPS, or the reference picture index of temporal mv candidate is implicitly derived. When the additional syntax element indicates that the reference picture index of temporal mv candidate is explicitly signaled, another additional syntax element is signaled in SH, PH, PPS and/or SPS to determine the reference picture index of temporal merge candidates. When the additional syntax element indicates that the reference picture index of temporal mv candidate is implicitly derived, any method described in the other embodiment can be used to derive the reference picture index.

In one embodiment, the reference picture used by the subblock-based temporal motion vector prediction (SbTMVP) could be different from the reference picture used by the temporal merge candidate (TMVP). For example, the reference picture index for the subblock-based temporal motion vector prediction (SbTMVP) could always be set to zero. For another example, the reference picture index associated with tb-td ratio closest to 1 is always selected for the subblock-based temporal motion vector prediction (SbTMVP). For still another example, the reference picture index associated with tb-td ratio closest to 1 is selected for the subblock-based temporal motion vector prediction (SbTMVP) when there is no backward prediction for the current picture, and the reference picture index for the subblock-based temporal motion vector prediction (SbTMVP) is set equal to zero when there is backward prediction for the current picture. For still another example, the reference picture index for the subblock-based temporal motion vector prediction (SbTMVP) is set equal to zero when there is no backward prediction for the current picture, and the reference picture index associated with tb-td ratio closest to 1 is selected for the subblock-based temporal motion vector prediction (SbTMVP) when there is backward prediction for the current picture.

In one embodiment, how to select the reference picture index of the current block could be determined by how the neighboring blocks select their reference picture index. For example, if the above neighboring block and the left neighboring block both set the reference picture index to zero, then the reference picture index of the current block is also set to zero. For another example, if the above neighboring block and the left neighboring block both select the reference picture index associated with tb-td ratio closest to 1, the current block also select the reference picture index associated with tb-td ratio closest to 1.

In one sub-embodiment, if the above neighboring block and the left neighboring block select the reference picture index with different method, for example, the above neighboring block set the reference picture index to zero and the left neighboring block select the reference picture index associated with tb-td ratio closest to 1, or vice versa, the reference picture index of the current block is set to zero. In another sub-embodiment, if the above neighboring block and the left neighboring block select the reference picture index with different method, for example, the above neighboring block set the reference picture index to zero and the left neighboring block select the reference picture index associated with tb-td ratio closest to 1, or vice versa, the reference picture index of the current block is the reference picture index associated with tb-td ratio closest to 1.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of video coding, comprising:
constructing an inter merge candidate list including one or more temporal merge candidates derived from motion information of a co-located coding unit (CU) in a co-located picture;
determining a reference picture index of the temporal merge candidate based on at least one criterion; and
performing inter prediction for a current CU using the temporal merge candidate with the determined reference picture index.

2. The method of claim 1, wherein determining the reference picture index comprises setting the reference picture index of the temporal merge candidate equal to zero.

3. The method of claim 1, wherein determining the reference picture index comprises setting the reference picture index equal to N, wherein N corresponds to a reference picture with a smallest picture order count (POC) distance from a current picture comprising the current CU.

4. The method of claim 1, wherein determining the reference picture index comprises:
identifying at least two reference pictures in a reference picture list with equal smallest POC distances from a current picture comprising the current CU; and
setting the reference picture index equal to an index, in the reference picture list, of the identified reference picture with a smaller POC.

5. The method of claim 1, wherein determining the reference picture index comprises:
identifying at least two reference pictures in a reference picture list with equal smallest POC distances from a current picture comprising the current CU; and
setting the reference picture index equal to an index, in the reference picture list, of the identified reference picture with a smaller quantization parameter (QP) difference relative to the current picture.

6. The method of claim 1, wherein determining the reference picture index comprises setting the reference picture index equal to N, wherein N corresponds to a reference picture with a smallest QP difference relative to a current picture comprising the current CU.

7. The method of claim 1, wherein determining the reference picture index comprises selecting a reference picture index associated with a smallest template cost between the temporal merge candidate and the current CU.

8. The method of claim 1, wherein determining the reference picture index comprises:
identifying a reference picture, in a reference picture list, with a ratio between a first POC difference and a second POC difference closest to one, wherein the first POC difference is between a current picture comprising the current CU and a reference picture for the current picture in the reference picture list, and wherein the second POC difference is between the co-located picture and a reference picture for the co-located picture; and
setting the reference picture index equal to an index, in the reference picture list, of the identified reference picture.

9. The method of claim 8, further comprising:
in response to multiple reference pictures in the reference picture list having ratios closest to one, selecting the reference picture with a same prediction direction as the co-located picture.

10. The method of claim 1, further comprising:
determining whether there is backward prediction for a current picture comprising the current CU;
in response to determining that there is no backward prediction, setting the reference picture index equal to zero; and
in response to determining that there is backward prediction:
identifying a reference picture, in a reference picture list, with a ratio between a first POC difference and a second POC difference closest to one, wherein the first POC difference is between a current picture comprising the current CU and a reference picture for the current picture in the reference picture list, and wherein the second POC difference is between the co-located picture and a reference picture for the co-located picture; and
setting the reference picture index equal to an index, in the reference picture list, of the identified reference picture.

11. The method of claim 1, further comprising:
determining whether there is backward prediction for a current picture comprising the current CU;
in response to determining that there is backward prediction, setting the reference picture index equal to zero; and
in response to determining that there is no backward prediction:
identifying a reference picture, in a reference picture list, with a ratio between a first POC difference and a second POC difference closest to one, wherein the first POC difference is between a current picture comprising the current CU and a reference picture for the current picture in the reference picture list, and wherein the second POC difference is between the co-located picture and a reference picture for the co-located picture; and
setting the reference picture index equal to an index, in the reference picture list, of the identified reference picture.

12. The method of claim 1, further comprising:
determining whether there is backward prediction for a current picture comprising the current CU;
in response to determining that there is no backward prediction, setting the reference picture index equal to an index determined based on one or more predetermined criteria; and
in response to determining that there is backward prediction:
identifying a reference picture, in a reference picture list, with a ratio between a first POC difference and a second POC difference closest to one, wherein the first POC difference is between a current picture comprising the current CU and a reference picture for the current picture in the reference picture list, and wherein the second POC difference is between the co-located picture and a reference picture for the co-located picture; and
setting the reference picture index equal to an index, in the reference picture list, of the identified reference picture.

13. The method of claim 1, further comprising:
determining whether there is backward prediction for a current picture comprising the current CU;
in response to determining that there is backward prediction, setting the reference picture index equal to an index determined based on one or more predetermined criteria; and
in response to determining that there is no backward prediction:
identifying a reference picture, in a reference picture list, with a ratio between a first POC difference and a second POC difference closest to one, wherein the first POC difference is between a current picture comprising the current CU and a reference picture for the current picture in the reference picture list, and wherein the second POC difference is between the co-located picture and a reference picture for the co-located picture; and
setting the reference picture index equal to an index, in the reference picture list, of the identified reference picture.

14. The method of claim 1, further comprising:
signaling, in at least one of a sequence parameter set, picture parameter set, adaptation parameter set, picture header, or slice header, a flag indicating whether the reference picture index of the temporal merge candidate is to be set equal to zero, an index determined according to a set of predetermined rules, or an index associated with a ratio closest to one.

15. The method of claim 14, further comprising:
signaling a syntax element in at least one of the sequence parameter set, the picture parameter set, the adaptation parameter set, the picture header, or the slice header to indicate whether the flag is signaled.

16. The method of claim 1, further comprising:
determining one or more criteria used to select reference picture indices for temporal merge candidates of one or more neighboring blocks of the current CU; and
determining the at least one criterion for the temporal merge candidate of the current CU based on the determined one or more criteria.

17. The method of claim 16, wherein the one or more criteria are determined to be setting respective reference picture indices to zero, wherein the at least one criterion is determined to be setting the reference picture index of the temporal merge candidate of the current CU to zero.

18. The method of claim 16, wherein the one or more criteria are determined to be selecting respective reference picture indices based on a ratio between a first POC difference and a second POC difference being closest to one, wherein the at least one criterion is determined to be selecting the reference picture index of the temporal merge candidate of the current CU based on the ratio between the first POC difference and the second POC difference being closest to one.

19. The method of claim 16, wherein a reference picture index of a temporal merge candidate of a first neighboring block of the one or more neighboring blocks is set to zero, wherein a reference picture index of a temporal merge candidate of a second neighboring block of the one or more neighboring blocks is a particular reference picture index selected for the second neighboring block based on a ratio between a first POC difference and a second POC difference associated with the second neighboring block,
wherein the at least one criterion is determined to be setting the reference picture index of the temporal merge candidate of the current CU to zero.

20. The method of claim 16, wherein a reference picture index of a temporal merge candidate of a first neighboring block of the one or more neighboring blocks is set to zero, wherein a reference picture index of a temporal merge candidate of a second neighboring block of the one or more neighboring blocks is a particular reference picture index selected for the second neighboring block based on a ratio between a first POC difference and a second POC difference, associated with the second neighboring block, being closest to one,
wherein the at least one criterion is determined to be selecting the reference picture index of the temporal merge candidate of the current CU based on a ratio between a first POC difference and a second POC difference, associated with the current CU, being closest to one.
